(19) United States
(12) Patent Application Publication
(10) Pub. No.: US 2015/0079977 A1
(43) Pub. Date: Mar. 19, 2015

(54) APPARATUS AND METHOD OF DYNAMICALLY MANAGING RESOURCES FOR INTERFERENCE CONTROL OF SATELLITE AND TERRESTRIAL INTEGRATED COMMUNICATION SYSTEM

(71) Applicant: Electronics and Telecommunications Research Institute, Daejeon (KR)

(72) Inventors: Un Hee PARK, Daejeon (KR); Hee Wook KIM, Daejeon (KR); Dae Sub OH, Daejeon (KR)

(21) Appl. No.: 14/469,298

(22) Filed: Aug. 26, 2014

(30) Foreign Application Priority Data
Sep. 16, 2013 (KR) 10-2013-0111411
Feb. 11, 2014 (KR) 10-2014-0015584

(51) Int. Cl. H04W 72/08; H04W 72/04; H04B 7/185

(52) U.S. Cl. CPC H04W 72/082; H04B 7/18539; H04W 72/0453
USPC 455/427; 455/12.1; 455/13.4

(57) ABSTRACT

An apparatus and method of dynamically managing resources for interference control of a satellite and terrestrial integrated communication system is disclosed, the apparatus including a frequency band determiner to determine a frequency band of a satellite beam and a frequency band of a wireless signal based on information on interference between the satellite beam and the wireless signal to which a frequency band identical to the satellite beam is allocated, and a remote controller to remotely control a space-based station to output a satellite beam at an intensity corresponding to a frequency band of a satellite beam, and an earth-based station to output a wireless signal at an intensity corresponding to a frequency band of a wireless signal.

### CROSS-REFERENCE TO RELATED APPLICATIONS

This application claims the priority benefit of Korean Patent Application No. 10-2013-0111411, filed on Sep. 16, 2013, and Korean Patent Application No. 10-2014-0015584, filed on Feb. 11, 2014, in the Korean Intellectual Property Office, the disclosures of which are incorporated herein by reference.

### BACKGROUND

1. Field of the Invention

Embodiments of the present invention relate to an apparatus and a method of dynamically managing resources for interference control of a satellite and terrestrial integrated communication system, and more particularly, to an apparatus and a method of avoiding interference between a satellite beam and a wireless signal by dynamically allocating power to a satellite beam and a wireless signal based on interference information of a satellite and terrestrial integrated communication system, and minimizing an intensity of the satellite beam and the wireless signal.

2. Description of the Related Art

A satellite and terrestrial integrated communication system refers to a system for providing both satellite communication and terrestrial communication using a single terminal. The satellite and terrestrial integrated communication system may exhibit high efficiency in frequency band utilization by re-using, in a terrestrial network, a frequency band allocated to a satellite beam from a satellite network.

However, a conventional satellite and terrestrial integrated communication system arbitrarily allocates channels in an available frequency band to a satellite beam and a wireless signal for a terrestrial communication service. Accordingly, it is likely that a frequency band may be allocated to the satellite beam and the wireless signal to which power greater than a bit rate required for a satellite beam and a wireless signal is transmitted. In this sense, allocation of unnecessary power may bring about an undesired increase in an intensity of a satellite beam and a wireless signal and thus, interference may occur between the satellite beam and the wireless signal to which an identical frequency band is allocated.

Accordingly, there is a need for a method of avoiding interference between a satellite beam and a wireless signal.

### SUMMARY

An aspect/embodiment of the present invention provides an apparatus and a method of avoiding interference between a satellite beam and a wireless signal by dynamically allocating power to a satellite beam and a wireless signal based on interference information, and minimizing an intensity of the satellite beam and the wireless signal.

According to an aspect of the present invention, there is provided an apparatus for dynamically managing resources, the apparatus including a frequency band determiner to determine a frequency band of a satellite beam and a frequency band of a wireless signal based on information on interference between the satellite beam and the wireless signal to which the frequency band identical to the satellite beam is allocated and an amount of generated traffic, and a remote controller to remotely control a satellite network space-based station to output the satellite beam at an intensity corresponding to the frequency band of the satellite beam, and remotely control a terrestrial network base station to output the wireless signal at an intensity corresponding to the frequency band of the wireless signal.

The apparatus for dynamically managing the resources may further include a frequency band allocator to allocate the frequency band of the wireless signal, to be identical to the frequency band of the satellite beam, to be output from the terrestrial network base station that receives a satellite beam differing from the satellite beam.

The frequency band determiner may determine the frequency band of the satellite beam and the frequency band of the wireless signal based on at least one of an amount of data required for a satellite beam, an average amount of power consumed to output a satellite beam, an antenna gain of a satellite beam, an amount of data required for a wireless signal, an average amount of power consumed to output a wireless signal, and an antenna gain of a wireless signal.

The frequency band determiner may determine a frequency band to minimize an intensity of the satellite beam and an intensity of the wireless signal to be the frequency band of the satellite beam and the frequency band of the wireless signal.

The frequency band determiner may control a bandwidth of the wireless signal based on a bandwidth of the satellite beam.

According to an aspect of the present invention, there is provided a satellite network space-based station including a beam generator to generate a satellite beam to be output to a coverage area, and a satellite beam outputter to allocate and output a frequency band of a satellite beam determined based on information on interference between a wireless signal to which a frequency band identical to the satellite beam is allocated and the satellite beam and an amount of data required for the wireless signal to which the frequency band identical to the satellite beam is allocated.

The satellite beam outputter may output the satellite beam at a minimum intensity to provide an amount of data required for the satellite beam, using transmitted power corresponding to the frequency band of the satellite beam.

According to an aspect of the present invention, there is provided a terrestrial network base station including a receiver to receive a frequency band of a wireless signal determined based on information on interference between a satellite beam to which a frequency band identical to the wireless signal is allocated and the wireless signal and an amount of data required for the wireless signal to which the frequency band identical to the satellite beam is allocated, and a wireless communicator to perform wireless communication by outputting, to a coverage area, a wireless signal to which the received frequency band of the wireless signal is allocated.

The wireless communicator may output the wireless signal at a minimum intensity to provide an amount data required for the wireless signal, using an amount of power corresponding to the frequency band of the wireless signal.

According to an aspect of the present invention, there is provided a method of dynamically managing resources, the method including determining a frequency band of a satellite beam and a frequency band of a wireless signal based on information on interference between the satellite beam and the wireless signal to which the frequency band identical to the satellite beam is allocated, and remotely controlling a satellite network space-based station to output a satellite beam at an intensity corresponding to the frequency band of the satellite beam, and remotely controlling a terrestrial network base station to output a wireless signal at an intensity corresponding to the frequency band of the wireless signal.

According to an aspect of the present invention, there is provided a method of dynamically managing resources, the method including generating a satellite beam to be output to a coverage area, and allocating and outputting a frequency band of a satellite beam determined based on information on interference between a wireless signal to which a frequency band identical to the satellite beam is allocated and the satellite beam and a required amount of generated traffic.

According to an aspect of the present invention, there is provided a method of dynamically managing resources, the method including receiving a frequency band of a wireless signal determined based on information on interference between a satellite beam to which a frequency band identical to the wireless signal is allocated and the wireless signal, and performing wireless communication by outputting, to a coverage area of a terrestrial network base station, a wireless signal to which the received frequency band of the wireless signal is allocated.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a satellite and terrestrial integrated communication system according to an embodiment of the present invention;

FIG. 2 is a diagram illustrating an example of a satellite and terrestrial integrated communication system according to an embodiment of the present invention;

FIG. 3 is a diagram illustrating an apparatus for dynamically managing resources according to an embodiment of the present invention;

FIG. 4 is a diagram illustrating a space-based station according to an embodiment of the present invention;

FIG. 5 is a diagram illustrating an earth-based station according to an embodiment of the present invention;

FIG. 6 is a diagram illustrating an example of an operation of a satellite and terrestrial integrated communication system according to an embodiment of the present invention; and

FIG. 7 is a flowchart illustrating a method of dynamically managing resources according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. According to an aspect of the present exemplary embodiment, a method of dynamically managing resources may be performed by an apparatus for dynamically managing resources included in a satellite and terrestrial integrated communication system.

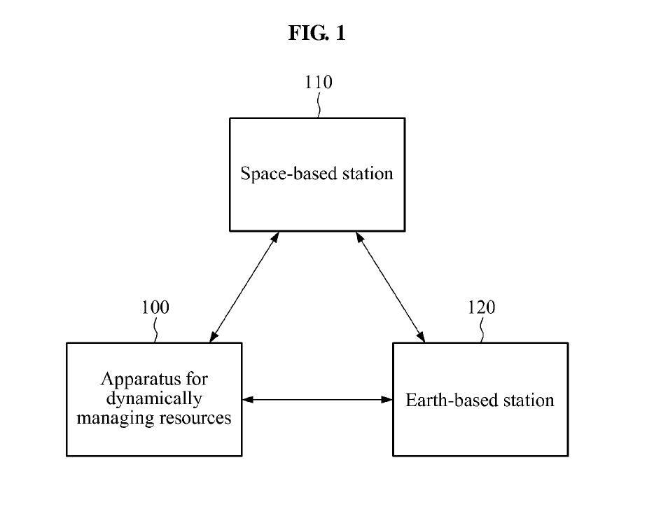

FIG. 1 is a diagram illustrating a satellite and terrestrial integrated communication system according to an embodiment of the present invention.

Referring to FIG. 1, the satellite and terrestrial integrated communication system includes an apparatus 100 for dynamically managing resources, a space-based station 110, and an earth-based station 120.

The space-based station 110 generates a plurality of satellite beams, and receives, from the apparatus 100 for dynamically managing the resources, frequency bands to be allocated to the satellite beams. The space-based station 110 allocates the received frequency bands to the satellite beams, and outputs each of the satellite beams to a plurality of satellite coverage areas. Here, the satellite coverage areas from which the satellite beams are output include a plurality of terrestrial coverage areas smaller than the satellite coverage areas.

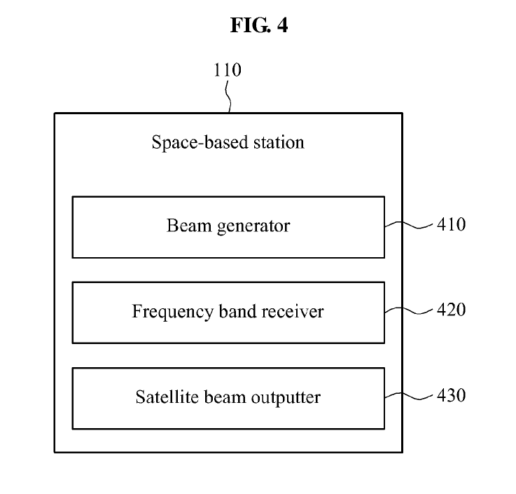

Descriptions pertaining to a configuration and an operation of the space-based station 110 will be provided in greater detail with reference to FIG. 4.

The earth-based station 120 performs wireless communication of a terrestrial network by receiving a satellite beam, and outputting a wireless signal corresponding to the received satellite beam to a terrestrial coverage area. In this example, a frequency band allocated to the wireless signal by the earth-based station 120 may differ from a frequency band of the received satellite beam. The earth-based station 120 may perform wireless communication with another earth-based station or a user terminal using a satellite beam and a wireless signal not corresponding to the wireless signal of the satellite beam.

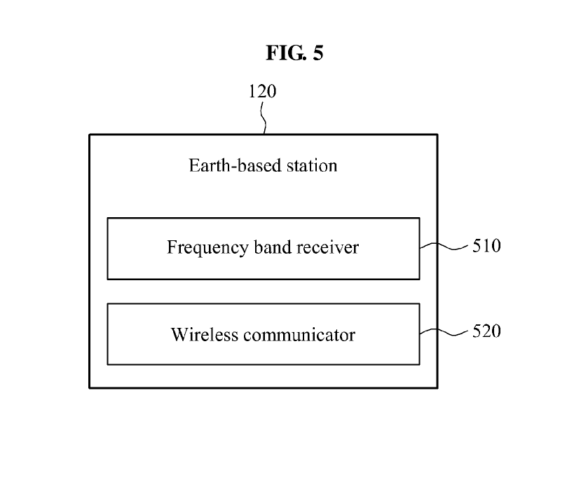

Descriptions pertaining to a configuration and an operation of the earth-based station 120 will be provided in greater detail with reference to FIG. 5.

The apparatus 100 for dynamically managing the resources re-uses a frequency band allocated to a satellite beam for a wireless signal of a terrestrial network. For example, the apparatus 100 for dynamically managing the resources allocates, to be identical to a frequency band of a satellite beam, a frequency band of a wireless signal used in a terrestrial coverage area included in a second satellite coverage area adjacent to and differing from a first satellite coverage area.

The apparatus 100 for dynamically managing the resources controls an intensity of the satellite beam output from the space-based station 110 and an intensity of the wireless signal output from the earth-based station 120. The satellite beam and the wireless signal are output from the space-based station 110 and the earth-based station 120, respectively, at an intensity greater than a predetermined value to transmit information. However, the greater the intensity of the satellite beam and the wireless signal, the greater the interference from satellite beam and wireless signal to which an identical frequency band is allocated. Accordingly, the apparatus 100 for dynamically managing the resources may avoid interference between the satellite beam and the wireless signal by controlling the intensity of the satellite beam output from the space-based station 110 and the intensity of the wireless signal output from the earth-based station 120 to be a minimum intensity to transmit information.

In this example, the apparatus 100 for dynamically managing the resources allocates an identical bandwidth to a satellite beam and to a wireless signal that re-uses a frequency band identical to the satellite beam. Here, the wireless signal may refer to a wireless signal that re-uses a frequency band identical to a satellite beam in a terrestrial coverage area included in a satellite coverage area adjacent to and differing from a satellite coverage area that outputs the satellite beam.

For example, the apparatus 100 for dynamically managing the resources may refer to a gateway earth-based station that connects a space-based network and another communication network, such as a terrestrial network.

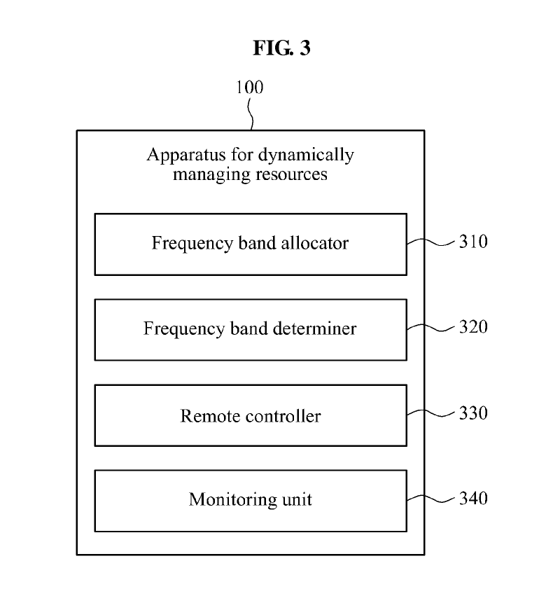

Descriptions pertaining to a configuration and an operation of the apparatus 100 for dynamically managing the resources will be provided in greater detail with reference to FIG. 3.

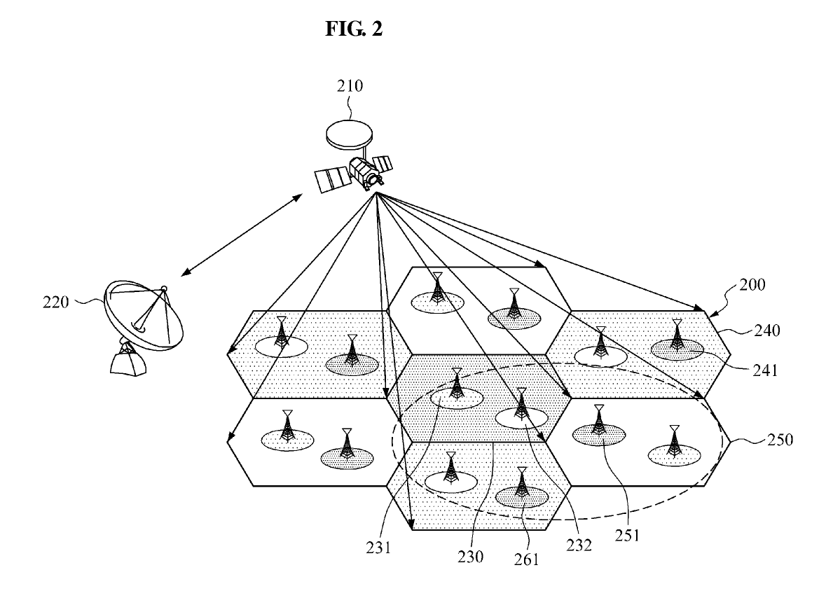

FIG. 2 is a diagram illustrating an example of a satellite and terrestrial integrated communication system according to an embodiment of the present invention.

Referring to FIG. 2, a space-based station 210 outputs satellite beams to a plurality of satellite coverage areas 200. The space-based station 210 forms a communication link with a gateway earth-based station 220. The space-based station 210 allocates the frequency band allocated by the gateway earth-based station 220 to each of the satellite beams, and outputs the allocated satellite beams.

Each of the satellite coverage areas 200 includes at least one terrestrial coverage area smaller than respective coverage areas of the satellite coverage areas 200. For example, a first satellite coverage area 230 includes a first terrestrial coverage area 231 and a second terrestrial coverage area 232. The gateway earth-based station 220 re-uses a frequency band allocated to a satellite beam in a terrestrial coverage area not included in the satellite coverage areas 200.

For example, the gateway earth-based station 220 allocates a frequency band W₁ to a first satellite beam to be output to the first satellite coverage area 230. The gateway earth-based station 220 allocates the frequency band W₁ to a third wireless signal used in a third terrestrial coverage area 241, a fourth wireless signal used in a fourth terrestrial coverage area 251, and a fifth wireless signal used in a fifth terrestrial coverage area 261. In this example, interference between the first satellite beam and the third wireless signal, the fourth wireless signal, and the fifth wireless signal may be relatively negligible because the third terrestrial coverage area 241, the fourth terrestrial coverage area 251, and the fifth terrestrial coverage area 261 are terrestrial coverage areas not included in the first satellite coverage area 230.

The gateway earth-based station 220 allocates, to a second wireless signal used in the first terrestrial coverage area 231 included in the first satellite coverage area 230, a frequency band W₂ allocated to a second satellite beam output to a second satellite coverage area 240. Also, the gateway earth-based station 220 allocates, to a third wireless signal used in the second terrestrial coverage area 232 included in the first satellite coverage area 230, a frequency band W₃ allocated to a third satellite beam output to a third satellite coverage area 250. In this example, interference between the first wireless signal and the second satellite beam that use an identical frequency band and interference between the second wireless signal and the third satellite beam that use an identical frequency band may be relatively negligible because the first terrestrial coverage area 231 is not included in the second satellite coverage area 240, and the second terrestrial coverage area 232 is not included in the third satellite coverage area 250.

Accordingly, the gateway earth-based station 220 may enhance spectrum efficiency and a communication capacity by re-using the frequency band allocated to the satellite beam in the terrestrial coverage area not included in the satellite coverage areas 200 to minimize interference.

However, an intensity of a satellite beam or a wireless signal may vary based on a magnitude of information to be transmitted. For example, when an intensity of at least one of a wireless signal and a satellite beam that use an identical frequency is strong another wireless signal or satellite beam that uses the identical frequency may interfere with the satellite beam or the wireless signal. Accordingly, the gateway earth-based station 220 may avoid interference between the satellite beam and the wireless signal by controlling the intensity of the satellite beam or the wireless signal to be a minimum intensity to transmit information.

FIG. 3 is a diagram illustrating the apparatus 100 for dynamically managing the resources according to an embodiment of the present invention.

Referring to FIG. 3, the apparatus 100 for dynamically managing the resources includes a frequency band allocator 310, a frequency band determiner 320, and a remote controller 330.

The frequency band allocator 310 allocates a frequency band of a wireless signal to be output from an earth-based station that receives a different satellite beam identical to a frequency band of a satellite beam. For example, the frequency band allocator 310 allocates, to be identical to a frequency band of a satellite beam, a frequency band of a wireless signal used in a terrestrial coverage area not included in a satellite coverage area. By way of example, the frequency band allocator 310 selects at least one wireless signal from among wireless signals used in a terrestrial coverage area included in a second satellite coverage area adjacent to and differing from a first satellite coverage area. The frequency band allocator 310 re-uses the frequency band allocated to the satellite beam as the frequency band of the wireless signal by allocating a frequency band of the selected wireless signal identical to the frequency band of the satellite beam.

The frequency band determiner 320 determines a frequency band of a satellite beam and a frequency band of a wireless signal based on information on interference between the satellite beam and the wireless signal to which a frequency band identical to the satellite beam is allocated by the frequency band allocator 310. The interference information may include at least one of an amount of data required for a satellite beam, average power consumed to output a satellite beam, an antenna gain of a satellite beam, an amount of data required for a wireless signal, average power consumed to output a wireless signal, and an antenna gain of a wireless signal.

An intensity of a satellite beam output from the space-based station 110 may be determined based on a magnitude of power corresponding to a frequency band allocated to the satellite beam. An intensity of a wireless signal output from the earth-based station 120 may be determined based on a magnitude of power corresponding to a frequency band allocated to the wireless signal. For example, the intensity of the satellite beam output from the space-based station 110 and the intensity of the wireless signal output from the earth-based station 120 may be controlled based on the frequency band of the satellite beam and the frequency band of the wireless signal determined by the frequency band determiner 320.

Accordingly, the frequency band determiner 320 controls the intensity of the satellite beam to be at a minimum intensity to provide an amount of data required for the satellite beam by determining a frequency band that minimizes the intensity of the satellite beam and the wireless signal to be the frequency band of the satellite beam. The frequency band determiner 320 controls the intensity of the wireless signal to be at a minimum intensity to provide an amount of data required for the wireless signal by determining the frequency band of the wireless signal allocated by the frequency band allocator 310 to be identical to the frequency band of the satellite beam.

The frequency band determiner 320 controls a bandwidth of the wireless signal based on a bandwidth of the satellite beam. For example, the frequency band determiner 320 determines the bandwidth of the wireless signal allocated by the frequency band allocator 310 to be identical to the bandwidth of the satellite beam.

According to an aspect of the present exemplary embodiments, interference occurring in a satellite and terrestrial integrated communication system may include interference on a satellite beam due to a wireless signal and interference on a wireless signal due to a satellite beam. For example, when a user in a satellite coverage area performs communication with an earth-based station, a communication signal transceived between a terminal of the user and the earth-based station may produce interference on a satellite beam that uses a frequency band identical to the communication signal. When the user in the satellite coverage area performs communication with a space-based station by forming a communication link with a satellite beam, the satellite beam transceived between the terminal of the user and the space-based station may produce interference on a communication signal of the earth-based station that uses the frequency band identical to the satellite beam.

The frequency band determiner 320 determines power consumption E_{b}(i)/N₀ required to output a satellite beam or a communication signal based on interference conditions as described in the preceding. For example, E_{b}(i)/N₀ is represented by Equation 1.

$$[ \begin{matrix}{Δ}_{1} & {0}_{N \times N} & {0}_{N \times N} & ⋯ & {0}_{N \times N} \\ {0}_{N \times N} & {Δ}_{2} & {0}_{N \times N} & ⋯ & {0}_{N \times N} \\ {0}_{N \times N} & {0}_{N \times N} & {Δ}_{3} & ⋯ & {0}_{N \times N} \\ ⋮ & ⋮ & ⋮ & ⋯ & ⋮ \\ {0}_{N \times N} & {0}_{N \times N} & {0}_{N \times N} & ⋯ & {Δ}_{N}\end{matrix} ] [ \begin{matrix}\frac{{E}_{b}}{{N}_{0}} ( 1 ) \\ \frac{{E}_{b}}{{N}_{0}} ( 2 ) \\ \frac{{E}_{b}}{{N}_{0}} ( 3 ) \\ ⋮ \\ \frac{{E}_{b}}{{N}_{0}} ( {N}^{2} )\end{matrix} ] = [ \begin{matrix}1 \\ 1 \\ 1 \\ ⋮ \\ 1\end{matrix} ] \qquad [ Equation 1 ]$$

In Equation 1, N denotes a rate of frequency re-use of a satellite and terrestrial integrated communication system, and Δ_{N}_{²} denotes a diagonal factor of a matrix. Δ_{N}_{²} may be a term associated with a satellite beam and a cell group that use an identical frequency band in the satellite and terrestrial integrated communication system and disposed within a common sphere of interference. For example, when the frequency re-usage rate N is “3” in the satellite and terrestrial integrated communication system, Δᵢ is calculated by Equation 2.

$${Δ}_{i} = [ \begin{matrix}\frac{1}{{ρ}_{1}^{i}} & - \frac{{R}_{b 2}^{i}}{{W}_{i}} {G}_{21}^{i} & - \frac{{R}_{b 3}^{i}}{{W}_{i}} {G}_{31}^{i} \\ - \frac{{R}_{b 1}^{i}}{{W}_{i}} {G}_{12}^{i} & \frac{1}{{ρ}_{2}^{i}} & 0 \\ - \frac{{R}_{b 1}^{i}}{{W}_{i}} {G}_{13}^{i} & 0 & \frac{1}{{ρ}_{3}^{i}}\end{matrix} ] \qquad [ Equation 2 ]$$

In Equation 2, Wᵢ denotes an i-th frequency band allocated to a satellite beam or a wireless signal when the satellite and terrestrial integrated communication system uses a frequency band Wₜₒₜ by dividing Wₜₒₜ into an N number of divisions. In this example, ΣWᵢ≦Wₜₒₜ is obtained because a total sum of frequency bands allocated to a satellite beam or a wireless signal does not exceed a bandwidth of the frequency band Wₜₒₜ used by the satellite and terrestrial integrated communication system. ρₖⁱ denotes an average power consumption. For example, ρₖⁱ is required power consumption averaged based on interference received by a satellite beam or a wireless signal, for example, calculated by E_{b}/(N₀+I₀). In this example, ρₖⁱ is determined by applying an appropriate adaptive power control (AMC) based on spectrum efficiency of achieving a Shannon capacity. E_{b}, N₀, and I₀ denote energy per bit, heat noise density, and interference power density, respectively. Here, ρₖⁱ is calculated by Equation 3 based on a communication capacity, for example, Cᵢ=Wᵢ log₂(1+ρⁱ) required to fully provide an amount of traffic of an i-th cell.

2^{R}^{_{b}}^{ⁱ}^{/W}^{ᵢ}−1 [Equation 3]

In ρₖⁱ, k denotes a constant to distinguish a satellite beam and a wireless signal that use an identical frequency band. For example, k=1 indicates a satellite beam, and k=2, 3 indicates a wireless signal that uses a frequency band identical to the satellite beam. When a first satellite beam is a satellite beam using a frequency band W₁, a second satellite beam is a satellite beam using a frequency band W₂, and a third satellite beam is a satellite beam using a frequency band W₃, ρ₁¹ is a power consumption required for the first satellite beam, ρ₂¹ is a power consumption required for a wireless signal that uses the frequency band W₁ in a terrestrial coverage area included in a coverage area of the second satellite beam, and ρ₃¹ is a power consumption required for a wireless signal that uses the frequency band W₁ in a terrestrial coverage area included in a coverage area of the third satellite beam.

R_{bk}ⁱ denotes a bit rate required for a satellite beam or a wireless signal. For example, R_{b1}¹ is a bit rate required for the first satellite beam using the frequency band W₁, and R_{b2}¹ is a bit rate required for the wireless signal using the frequency band W₁ in the terrestrial coverage area included in the coverage area of the second satellite beam. G_{k,k}ⁱ=g_{k,k′}/g_{k,k} is a constant associated with an antenna gain. For example, g_{k,k′} is an antenna gain from a k′-th satellite beam or a wireless signal to a k-th satellite beam or a wireless signal. The antenna gain from the k′-th satellite beam or the wireless signal to the k-th satellite beam or the wireless signal is an amount of interference inflicted on the k-th satellite beam or the wireless signal by the k′-th satellite beam or the wireless signal. g_{k,k} is an antenna gain of the k-th satellite beam or the wireless signal in the k-th satellite beam or the wireless signal.

For example, information about a satellite beam and a wireless signal using a frequency band W₁ is represented by Table 1. Information about a satellite beam and a wireless signal using a frequency band W₂ is represented by Table 2. Information about a satellite beam and a wireless signal using a frequency band W₃ is represented by Table 3.

TABLE 1

| | Required | | Average | |
|---|---|---|---|---|
| | power | Required | power | Antenna |
| | consumption | bit rate | consumption | gain |
| First satellite beam | $\frac{{E}_{b}^{sat}}{{N}_{0}} ( 1 )$ | R_{b1}⁽¹⁾ | ρ₁⁽¹⁾ | G₁₂⁽¹⁾, G₁₃⁽¹⁾ |
| Wireless signal in coverage area of second | $\frac{{E}_{b}^{t 1}}{{N}_{0}} ( 1 )$ | R_{b2}⁽¹⁾ | ρ₂⁽¹⁾ | G₂₁⁽¹⁾ |
| satellite beam | | | | |
| Wireless signal in coverage area of third | $\frac{{E}_{b}^{t 2}}{{N}_{0}} ( 1 )$ | R_{b3}⁽¹⁾ | ρ₃⁽¹⁾ | G₃₁⁽¹⁾ |
| satellite beam | | | | |

TABLE 2

| | Required | | Average | |
|---|---|---|---|---|
| | power | Required | power | Antenna |
| | consumption | bit rate | consumption | gain |
| Second satellite beam | $\frac{{E}_{b}^{sat}}{{N}_{0}} ( 2 )$ | R_{b1}⁽²⁾ | ρ₁⁽²⁾ | G₁₂⁽²⁾, G₁₃⁽²⁾ |
| Wireless signal in coverage area of first | $\frac{{E}_{b}^{t 1}}{{N}_{0}} ( 2 )$ | R_{b2}⁽²⁾ | ρ₂⁽²⁾ | G₂₁⁽²⁾ |
| satellite beam | | | | |
| Wireless signal in coverage area of third | $\frac{{E}_{b}^{t 2}}{{N}_{0}} ( 2 )$ | R_{b3}⁽²⁾ | ρ₃⁽²⁾ | G₃₁⁽²⁾ |
| satellite beam | | | | |

TABLE 3

| | Required | | Average | |
|---|---|---|---|---|
| | power | Required | power | Antenna |
| | consumption | bit rate | consumption | gain |
| Third satellite beam | $\frac{{E}_{b}^{sat}}{{N}_{0}} ( 3 )$ | R_{b1}⁽³⁾ | ρ₁⁽³⁾ | G₁₂⁽³⁾, G₁₃⁽³⁾ |
| Wireless signal in coverage area of first | $\frac{{E}_{b}^{t 1}}{{N}_{0}} ( 3 )$ | R_{b2}⁽³⁾ | ρ₂⁽³⁾ | G₂₁⁽³⁾ |
| satellite beam | | | | |
| Wireless signal in coverage area of second | $\frac{{E}_{b}^{t 2}}{{N}_{0}} ( 3 )$ | R_{b3}⁽³⁾ | ρ₃⁽³⁾ | G₃₁⁽³⁾ |
| satellite beam | | | | |

The frequency band determiner 320 may enhance efficiency of the satellite and terrestrial integrated communication system by minimizing power consumption E_{b}/N₀ required to satisfy a required bit rate of a satellite beam or a wireless signal. For example, the frequency band determiner 320 allocates an identical bandwidth to a satellite beam and a wireless signal that use an identical frequency band to minimize interference within the satellite and terrestrial integrated communication system during a process of adjusting the power consumption. By way of example, an operation of the frequency band determiner 320 is represented by Equation 4.

$${min}_{{forW}_{i}} {\sum }_{i = 1}^{N} \{ \frac{{E}_{b}^{sat}}{{N}_{0}} ( i ) + \frac{{E}_{b}^{t 1}}{{N}_{0}} ( i ) + \frac{{E}_{b}^{t 2}}{{N}_{0}} ( i ) \} \\ for i = 1 , 2 , … , N ( N = frequency reuse factor ) \qquad [ Equation 4 ]$$

In Equation 4, a sum of power consumption for a satellite beam that uses a frequency band Wᵢ and power consumption of a wireless signal of a terrestrial network that uses the identical frequency band Wᵢ in a coverage area of another satellite beam adjacent to a coverage area of the satellite beam, denoted by E_{b}/N₀, is calculated. Accordingly, Equation 5 is obtained by simplifying Equation 4 based on Equations 1 and 2.

$$\frac{{E}_{b}^{sat}}{{N}_{0}} ( i ) = \frac{{ρ}_{1}^{i} + \frac{{r}_{b 2}^{i}}{{W}_{i}} {ρ}_{1}^{i} {ρ}_{2}^{i} {G}_{12}^{i} + \frac{{R}_{b 3}}{{W}_{i}} {ρ}_{1}^{i} {ρ}_{3}^{i} {G}_{31}^{i}}{\begin{matrix}1 - \frac{{R}_{b 1}^{i} {R}_{b 2}^{i}}{{W}_{i}^{2}} {ρ}_{1}^{i} {ρ}_{2}^{i} {G}_{12}^{i} {G}_{21}^{i} - \\ \frac{{R}_{b 1}^{i} {R}_{b 3}^{i}}{{W}_{i}^{2}} {ρ}_{1}^{i} {ρ}_{3}^{i} {G}_{13}^{i} {G}_{31}^{i}\end{matrix}} , \\ \frac{{E}_{b}^{t 1}}{{N}_{0}} ( i ) = {ρ}_{2}^{i} \{ 1 + \frac{{r}_{b 1}^{i}}{{W}_{i}} {g}_{12}^{i} \frac{{E}_{b}^{sat}}{{N}_{0}} ( i ) \} , \\ \frac{{E}_{b}^{t 2}}{{N}_{0}} ( i ) = {ρ}_{3}^{i} \{ 1 + \frac{{r}_{b 1}^{i}}{{W}_{i}} {g}_{13}^{i} \frac{{E}_{b}^{sat}}{{N}_{0}} ( i ) \} . \qquad [ Equation 5 ]$$

A total sum of frequency bands allocated to a satellite beam and a wireless signal from the satellite and terrestrial integrated communication system is limited to a bandwidth used by the satellite and terrestrial integrated communication system. For example, such limitations determined by the frequency band determiner 320 are expressed by Equations 6 and 7.

$$\begin{matrix}{\sum }_{i = 1}^{N} {W}_{i} \leq {W}_{tot} for i = 1 , 2 , … , N & [ Equation 6 ] \\ - {W}_{i} < 0 for i = 1 , 2 , … , N & [ Equation 7 ]\end{matrix}$$

By way of example, a limitation of allocating a bandwidth greater than zero to a satellite beam and a wireless signal is represented by Equation 7. The frequency band determiner 320 uses Equation 8 by applying a Lagrangian function to solve an optimization issue with respect to a cost function represented by Equation 5 and the aforementioned limitations represented by Equations 6 and 7.

$$L ( {W}_{i} , {λ}_{i} ) = {\sum }_{i = 1}^{N} \{ \frac{{E}_{b}^{sat}}{{N}_{0}} ( i ) + \frac{{E}_{b}^{t 1}}{{N}_{0}} ( i ) + \frac{{E}_{b}^{t 2}}{{N}_{0}} ( i ) \} + {λ}_{i} ( {\sum }_{i = 1}^{N} {W}_{i} - {W}_{tot} ) - {λ}_{2} ( {\sum }_{i = 1}^{N} {W}_{i} ) \qquad [ Equation 8 ]$$

In Equation 8, λ₁ and λ₂ denote Lagrange multipliers, and may be simplified by applying Karush-Kuhn-Tucker (KKT) conditions to be represented by Equations 9 and 10.

λ₁,λ₂≧0 [Equation 9]

λ₂Wᵢ=0 [Equation 10]

λ₂ may be zero to satisfy Equation 10 because Wᵢ≠0 as expressed by Equation 7. Accordingly, Equation 11 is obtained by simplifying Equation 8 with respect to λ₁ based on

$$\frac{\partial L ( {W}_{i} , {λ}_{i} )}{\partial {λ}_{i}} = 0$$

of the KKT conditions.

$${λ}_{1} = \frac{\begin{matrix}( B + D + F ) {W}_{i}^{2} + \\ ( AC + 2 DE + 2 EF ) {W}_{i} + CG\end{matrix}}{{W}_{i}^{4} - 2 {CW}_{i}^{2} + {C}^{2}} \qquad [ Equation 11 ]$$

A, B, C, D, E, and F in Equation 11 may be calculated by Equation 12.

A=2ρ₁ⁱ,

B=R_{b2}ⁱρ₁ⁱρ₂ⁱg₂₁ⁱ+R_{b3}ⁱρ₁ⁱρ₃ⁱg₃₁ⁱ,

C=R_{b1}ⁱR_{b2}ⁱρ₁ⁱρ₂ⁱg₁₂ⁱg₂₁ⁱ+R_{b1}ⁱR_{b3}ⁱρ₁ⁱρ₃ⁱg₁₃ⁱg₃₁ⁱ,

D=R_{b1}ⁱρ₁ⁱρ₂ⁱg₁₂ⁱ,

E=R_{b2}ⁱρ₂ⁱg₂₁ⁱ+R_{b3}ⁱρ₃ⁱg₃₁ⁱ,

F=R_{b1}ⁱρ₁ⁱρ₃ⁱg₁₃ⁱ [Equation 12]

Equation 13 is obtained by simplifying Equation 12 with respect to Wᵢ.

λ₁Wᵢ⁴−(2Cλ₁+B+D+F)Wᵢ²−(AC+2DE+2EF)Wᵢ+λ₁C²−C(B+D+F)=0 [Equation 13]

The frequency band determiner 320 calculates a solution Wᵢ given by Equation 13 to determine a frequency band of a satellite beam or a wireless signal to minimize an amount of power required to provide a bit rate occurring in each of a satellite coverage area and a terrestrial coverage area.

The remote controller 330 remotely controls the space-based station 110 to output a satellite beam at an intensity corresponding to the frequency band of the satellite beam determined by the frequency band determiner 320. The remote controller 330 remotely controls the earth-based station 120 to output a wireless signal at an intensity corresponding to the frequency band of the wireless signal determined by the frequency band determiner 320.

For example, the remote controller 330 transmits, to the space-based station 110, the frequency band of the satellite beam determined by the frequency band determiner 320, and a control signal to control the space-based station 110 to output a satellite beam. The remote controller 330 transmits, to the earth-based station 120, the frequency band of the wireless signal determined by the frequency band determiner 320, and a control signal to control the earth-based station 120 to output a wireless signal.

The space-based station 110 allocates the received frequency band of the satellite beam to the satellite beam, and outputs the satellite beam based on the received control signal. The space-based station 110 outputs the satellite beam using an amount of power corresponding to the frequency band of the satellite beam. An intensity of the satellite beam output from the space-based station 110 may be a minimum intensity required to provide an amount of data required for the satellite beam.

The earth-based station 120 allocates the received frequency band of the wireless signal to the wireless signal, and outputs the wireless signal based on the received control signal. The earth-based station 120 outputs the wireless signal using power corresponding to the frequency band of the wireless signal. An intensity of the wireless signal output from the earth-based station 120 may be a minimum intensity required to provide an amount of data required for the wireless signal.

The monitoring unit 340 performs monitoring on interference information of a wireless signal and interference information of a satellite beam. For example, the monitoring unit 340 performs monitoring on a change in an amount of data required for a satellite beam, an average power consumed to output a satellite beam, an antenna gain of a satellite beam, an amount of data required for a wireless signal, the average power consumed to output a wireless signal, and an antenna gain of a wireless signal.

When at least one of the interference information of the wireless signal and the interference information of the satellite beam changes, the monitoring unit 340 requests the frequency band determiner 320 to re-determine a frequency band. In this example, the frequency band determiner 320 determines the frequency band of the satellite beam and the frequency band of the wireless signal based on the changed interference information of the wireless signal and the interference information of the satellite beam.

FIG. 4 is a diagram illustrating the space-based station 110 according to an embodiment of the present invention.

Referring to FIG. 4, the space-based station 110 includes a beam generator 410, a frequency band receiver 420, and a satellite beam outputter 430.

The beam generator 410 generates a plurality of satellite beams to be output to a satellite coverage area.

The frequency band receiver 420 receives, from the apparatus 100 for dynamically managing the resources, a frequency band of a satellite beam determined by the apparatus 100 for dynamically managing the resources. The frequency band of the satellite beam received by the frequency band receiver 420 may be a frequency band determined, by the apparatus 100 for dynamically managing the resources, to output a satellite beam at a minimum intensity to provide an amount of data required for the satellite beam based on interference between the satellite beam and a wireless signal to which a frequency band identical to the satellite beam is allocated.

The satellite beam outputter 430 allocates the frequency band received by the frequency band receiver 420 to the satellite beam generated by the beam generator 410, and outputs the allocated frequency band. In this example, the satellite beam outputter 430 allocates power to output the satellite beam based on a plurality of frequency bands. The satellite beam outputter 430 outputs the satellite beam at a minimum intensity to provide an amount of data required for the satellite beam without additional equipment to control power by outputting the satellite beam using power corresponding to the received frequency band.

FIG. 5 is a diagram illustrating the earth-based station 120 according to an embodiment of the present invention.

Referring to FIG. 5, the earth-based station 120 includes a frequency band receiver 510 and a wireless communicator 520.

The frequency band receiver 510 receives a frequency band of a wireless signal from the apparatus 100 for dynamically managing the resources. The frequency band of the wireless signal received by the frequency band receiver 510 may be a frequency band determined, by the apparatus 100 for dynamically managing the resources, to output a wireless signal at a minimum intensity to provide an amount of data required for the wireless signal based on interference between a satellite beam to which a frequency band identical to the wireless signal is allocated and the wireless signal.

The frequency band receiver 510 performs satellite communication via the space-based station 110 by receiving a satellite beam and forming a communication link with the space-based station 110. For example, the frequency band receiver 510 forms a communication link with the apparatus 100 for dynamically managing the resources via the space-based station 110, and receives the frequency band of the wireless signal from the apparatus 100 for dynamically managing the resources. The frequency band receiver 510 performs satellite communication with an earth-based station disposed in a different satellite coverage area via the space-based station 110.

The wireless communicator 520 performs wireless communication by outputting, to a terrestrial coverage area, the wireless signal to which the frequency band received by the frequency band receiver 510 is allocated. In this example, the wireless communicator 520 allocates power to output a wireless signal based on a plurality of frequency bands. The wireless communicator 520 outputs a wireless signal at a minimum intensity to provide an amount of data required for the wireless signal without additional equipment to control power by outputting the wireless signal using power corresponding to the received frequency band.

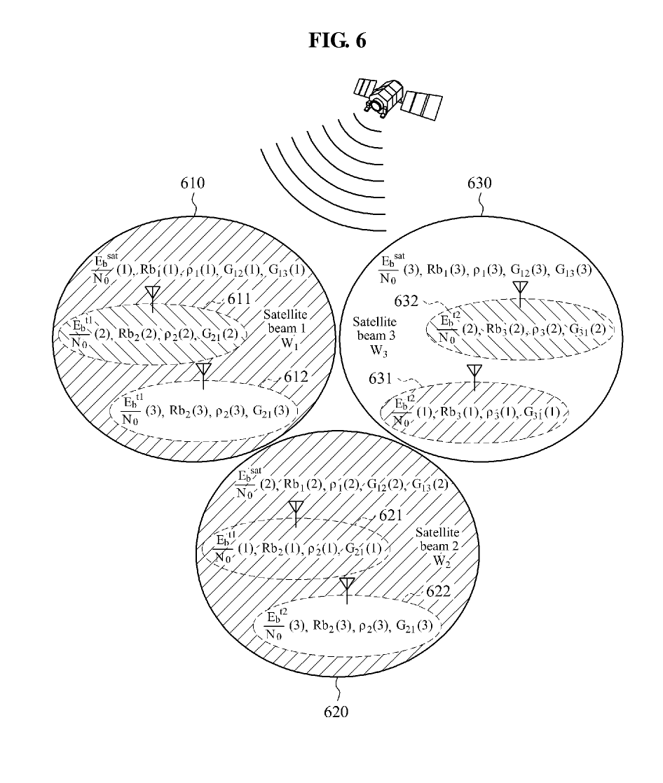

FIG. 6 is a diagram illustrating an example of an operation of a satellite and terrestrial integrated communication system according to an embodiment of the present invention.

Referring to FIG. 6, an identical frequency band is allocated to a first satellite beam output to a first satellite coverage area 610, a third wireless signal used in a third terrestrial coverage area 621 included in a second satellite coverage area 620, and a fifth wireless signal used in a fifth terrestrial coverage area 631 included in a third satellite coverage area 630. In this example, the apparatus 100 for dynamically managing the resources determines a frequency band of the first satellite beam, the third wireless signal, and the fifth wireless signal to be W₁ based on interference information of the first satellite beam, the third wireless signal, and the fifth wireless signal. By way of example, the apparatus 100 for dynamically managing the resources determines W₁, for example, a result of applying, to Equation 12, required power consumption, a required bit rate, average power consumption, and an antenna gain for all of the first satellite beam, the third wireless signal, and the fifth wireless signal, to be the frequency band of the first satellite beam, the third wireless signal, and the fifth wireless signal. In detail, a power consumption

$$\frac{{E}_{b}^{sat}}{{N}_{0}} ( 1 )$$

required for the first satellite beam, a bit rate R_{b1}⁽¹⁾ required for the first satellite beam, an average power consumption ρ₁⁽¹⁾ of the first satellite beam, and antenna gains G₁₂⁽¹⁾, G₁₃⁽¹⁾ of the first satellite beam, a power consumption

$$\frac{{E}_{b}^{t 1}}{{N}_{0}} ( 1 )$$

required for the third wireless signal, a bit rate R_{b2}⁽¹⁾ required for the third wireless signal, an average power consumption ρ₂⁽¹⁾ of the third wireless signal, and an antenna gain G₂₁⁽¹⁾ of the third wireless signal, and a power consumption

$$\frac{{E}_{b}^{t 2}}{{N}_{0}} ( 1 )$$

required for the fifth wireless signal, a bit rate R_{b3}⁽¹⁾ required for the fifth wireless signal, an average power consumption ρ₃⁽¹⁾ of the fifth wireless signal, and an antenna gain G₃₁⁽¹⁾ of the fifth wireless signal are applied to Equation 13.

Also, in FIG. 6, an identical frequency band is allocated to a second satellite beam output to the second satellite coverage 620, a first wireless signal used in a first terrestrial coverage area 611 included in a first satellite coverage area 610, and a sixth wireless signal used in a sixth terrestrial coverage area 632 included in the third satellite coverage area 630. In this example, the apparatus 100 for dynamically managing the resources determines a frequency band of the second satellite beam, the first wireless signal, and the sixth wireless signal to be W₂ based on interference information of the second satellite beam, the first wireless signal, and the sixth wireless signal. By way of example, the apparatus 100 for dynamically managing the resources determines W₂, for example, a result of applying, to Equation 13, required power consumption, a required bit rate, average power consumption, and an antenna gain for all of the second satellite beam, the first wireless signal, and the sixth wireless signal, to be the frequency band of the second satellite beam, the first wireless signal, and the sixth wireless signal. In detail, a power consumption

$$\frac{{E}_{b}^{sat}}{{N}_{0}} ( 2 )$$

required for the second satellite beam, a bit rate R_{b1}⁽²⁾ required for the second satellite beam, an average power consumption ρ₁⁽²⁾ of the second satellite beam, and antenna gains G₁₂⁽²⁾, G₁₃⁽²⁾ of the second satellite beam, a power consumption

$$\frac{{E}_{b}^{t 1}}{{N}_{0}} ( 2 )$$

required for the first wireless signal, a bit rate R_{b2}⁽²⁾ required for the first wireless signal, an average power consumption ρ₂⁽²⁾ of the first wireless signal, and an antenna gain G₂₁⁽²⁾ of the first wireless signal, and a power consumption

$$\frac{{E}_{b}^{t 2}}{{N}_{0}} ( 2 )$$

required for the sixth wireless signal, a bit rate R_{b3}⁽²⁾ required for the sixth wireless signal, an average power consumption ρ₃⁽²⁾ of the sixth wireless signal, and an antenna gain G₃₁⁽²⁾ of the sixth wireless signal are applied to Equation 12.

Further, in FIG. 6, an identical frequency band is allocated to a third satellite beam output to the third satellite coverage 630, a second wireless signal used in a second terrestrial coverage area 612 included in the first satellite coverage area 610, and a fourth wireless signal used in a fourth terrestrial coverage area 622 included in the second satellite coverage area 620. In this example, the apparatus 100 for dynamically managing the resources determines a frequency band of the third satellite beam, the second wireless signal, and the fourth wireless signal to be W₃ based on interference information of the third satellite beam, the second wireless signal, and the fourth wireless signal. By way of example, the apparatus 100 for dynamically managing the resources determines W₃, for example, a result of applying, to Equation 12, a required power consumption, a required bit rate, an average power consumption, and an antenna gain of all of the third satellite beam, the second wireless signal, and the fourth wireless signal, to be the frequency band of the third satellite beam, the second wireless signal, and the fourth wireless signal. In detail, a power consumption

$$\frac{{E}_{b}^{sat}}{{N}_{0}} ( 3 )$$

required for the third satellite beam, a bit rate R_{b1}⁽³⁾ required for the third satellite beam, an average power consumption ρ₁⁽³⁾ of the third satellite beam, and antenna gains G₁₂⁽³⁾, G₁₃⁽³⁾ of the third satellite beam, a power consumption

$$\frac{{E}_{b}^{t 1}}{{N}_{0}} ( 3 )$$

required for the second wireless signal, a bit rate R_{b2}⁽³⁾ required for the second wireless signal, an average power consumption ρ₂⁽³⁾ of the second wireless signal, and an antenna gain G₂₁⁽³⁾ of the second wireless signal, and a power consumption

$$\frac{{E}_{b}^{t 2}}{{N}_{0}} ( 3 )$$

required for the fourth wireless signal, a bit rate R_{b2}⁽³⁾ required for the fourth wireless signal, an average power consumption ρ₃⁽³⁾ of the fourth wireless signal, and an antenna gain G₂₁⁽³⁾ of the fourth wireless signal are applied to Equation 12.

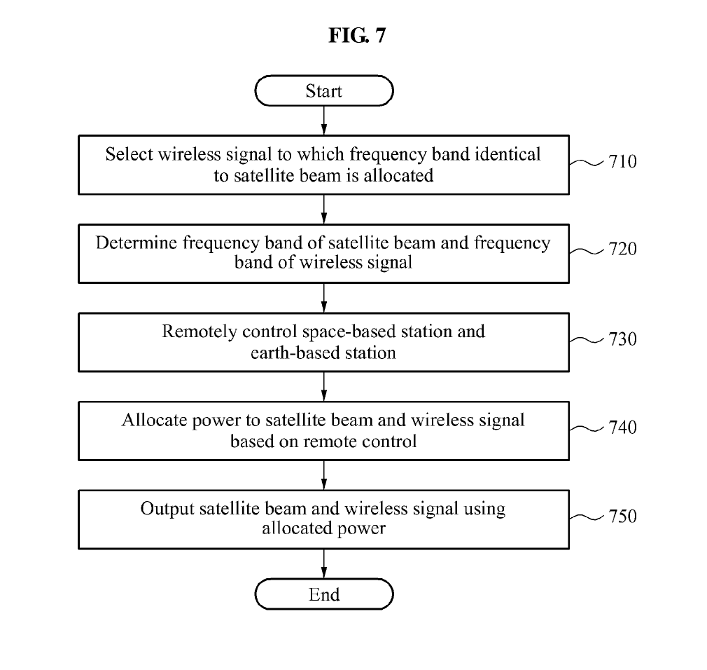

FIG. 7 is a flowchart illustrating a method of dynamically managing resources according to an embodiment of the present invention.

In operation 710, the frequency band allocator 310 selects a wireless signal to be allocated to a frequency band identical to a satellite beam. For example, the frequency band allocator 310 selects at least one wireless signal from among wireless signals used in a terrestrial coverage area included in a second satellite coverage area adjacent to and differing from a first satellite coverage area. The frequency band allocator 310 re-uses the frequency band allocated to the satellite beam as the frequency band of the wireless signal by allocating the frequency band of the selected wireless signal to be identical to the frequency band of the satellite beam.

In operation 720, the frequency band determiner 320 determines the frequency band of the satellite beam and the frequency band of the wireless signal based on information on interference between the satellite beam and the wireless signal to which the frequency band identical to the satellite beam is allocated in operation 710. In this example, the frequency band determiner 320 controls an intensity of the satellite beam to be at a minimum intensity to provide an amount of data required for the satellite beam by determining a frequency band to minimize the intensity of the satellite beam and an intensity of the wireless signal to be the frequency band of the satellite beam. The frequency band determiner 320 controls the intensity of the wireless signal to be at a minimum intensity to provide an amount of data required for the wireless signal by determining the frequency band of the wireless signal allocated by the frequency band allocator 310 to be identical to the frequency band of the satellite beam.

In operation 730, the remote controller 330 remotely controls the space-based station 110 to output a satellite beam at an intensity corresponding to the frequency band of the satellite beam determined in operation 730. The remote controller 330 remotely controls the earth-based station 120 to output a wireless signal at an intensity corresponding to the frequency band of the wireless signal determined in operation 730. For example, the remote controller 330 transmits, to the space-based station 110, the frequency band of the satellite beam determined by the frequency band determiner 320 and a control signal to control the space-based station 110 to output a satellite beam. The remote controller 330 transmits, to the earth-based station 120, the frequency band of the wireless signal determined by the frequency band determiner 320 and a control signal to control the earth-based station 120 to output a wireless signal.

In operation 740, the space-based station 110 allocates the frequency band of the satellite beam received in operation 730 to a satellite beam. The earth-based station 120 allocates the frequency band of the wireless signal received in operation 730 to a wireless signal.

In operation 750, the space-based station 110 outputs the satellite beam based on the control signal received in operation 730. In this example, the space-based station 110 outputs the satellite beam using an amount of power corresponding to the frequency band of the satellite beam allocated in operation 740. An intensity of the satellite beam output from the space-based station 110 is a minimum intensity to provide an amount of data required for the satellite beam.

The earth-based station 120 outputs the wireless signal based on the control signal received in operation 730. In this example, the earth-based station 120 outputs the wireless signal using power corresponding to the frequency band of the wireless signal allocated in operation 740. An intensity of the wireless signal output from the earth-based station 120 is a minimum intensity to provide an amount of data required for the wireless signal.

According to an aspect of the present invention, it is possible to avoid interference between a satellite beam and a wireless signal by dynamically allocating a frequency band to the satellite beam and the wireless signal based on interference information, and minimizing an intensity of power to be used to output the satellite beam and the wireless signal.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for dynamically managing resources, the apparatus comprising:
a frequency band determiner to determine a frequency band of a satellite beam and a frequency band of a wireless signal based on information on interference between the satellite beam and the wireless signal to which the frequency band identical to the satellite beam is allocated and an amount of generated traffic; and
a remote controller to remotely control a satellite network space-based station to output the satellite beam at an intensity corresponding to the frequency band of the satellite beam, and remotely control a terrestrial network base station to output the wireless signal at an intensity corresponding to the frequency band of the wireless signal.

2. The apparatus of claim 1, further comprising:
a frequency band allocator to allocate the frequency band of the wireless signal, to be identical to the frequency band of the satellite beam, to be output from the terrestrial network base station that receives a satellite beam differing from the satellite beam.

3. The apparatus of claim 1, wherein the frequency band determiner determines the frequency band of the satellite beam and the frequency band of the wireless signal based on at least one of an amount of data required for a satellite beam, an average amount of power consumed to output a satellite beam, an antenna gain of a satellite beam, an amount of data required for a wireless signal, an average amount of power consumed to output a wireless signal, and an antenna gain of a wireless signal.

4. The apparatus of claim 1, wherein the frequency band determiner determines a frequency band to minimize an intensity of the satellite beam and an intensity of the wireless signal to be the frequency band of the satellite beam and the frequency band of the wireless signal.

5. The apparatus of claim 1, wherein the frequency band determiner controls a bandwidth of the wireless signal based on a bandwidth of the satellite beam.

6. A satellite network space-based station comprising:
a beam generator to generate a satellite beam to be output to a coverage area; and
a satellite beam outputter to allocate and output a frequency band of a satellite beam determined based on information on interference between a wireless signal to which a frequency band identical to the satellite beam is allocated and the satellite beam and an amount of data required for the wireless signal to which the frequency band identical to the satellite beam is allocated.

7. The apparatus of claim 6, wherein the satellite beam outputter outputs the satellite beam at a minimum intensity to provide an amount of data required for the satellite beam, using transmitted power corresponding to the frequency band of the satellite beam.

8. A terrestrial network base station comprising:
a receiver to receive a frequency band of a wireless signal determined based on information on interference between a satellite beam to which a frequency band identical to the wireless signal is allocated and the wireless signal and an amount of data required for the wireless signal to which the frequency band identical to the satellite beam is allocated; and
a wireless communicator to perform wireless communication by outputting, to a coverage area, a wireless signal to which the received frequency band of the wireless signal is allocated.

9. The apparatus of claim 8, wherein the wireless communicator outputs the wireless signal at a minimum intensity to provide an amount data required for the wireless signal, using an amount of power corresponding to the frequency band of the wireless signal.

10. The apparatus of claim 8, wherein the wireless communicator receives a satellite beam, and outputs a wireless signal based on the received satellite beam, and
the frequency band of the wireless signal differs from a frequency band of the satellite beam received by the wireless communicator.

11. A method of dynamically managing resources, the method comprising:
determining a frequency band of a satellite beam and a frequency band of a wireless signal based on information on interference between the satellite beam and the wireless signal to which the frequency band identical to the satellite beam is allocated and a required amount of generated traffic; and
remotely controlling a satellite network space-based station to output a satellite beam at an intensity corresponding to the frequency band of the satellite beam, and remotely controlling a terrestrial network base station to output a wireless signal at an intensity corresponding to the frequency band of the wireless signal.

12. The method of claim 11, further comprising:
allocating the frequency band of the wireless signal, to be identical to the frequency band of the satellite beam, to be output from the terrestrial network base station that receives a satellite beam differing from the satellite beam.

13. The method of claim 11, wherein the determining of the frequency band comprises:
determining the frequency band of the satellite beam and the frequency band of the wireless signal based on at least one of an amount of data required for a satellite beam, an average amount of power consumed to output a satellite beam, an antenna gain of a satellite beam, an amount of data required for a wireless signal, an average amount of power consumed to output a wireless signal, and an antenna gain of a wireless signal.

14. The method of claim 11, wherein the determining of the frequency band comprises:
determining a frequency band to minimize an intensity of the satellite beam and an intensity of the wireless signal to be the frequency band of the satellite beam and the frequency band of the wireless signal.

15. The method of claim 11, wherein the determining of the frequency band comprises:
controlling a bandwidth of the wireless signal based on a bandwidth of the satellite beam.

16. A method of dynamically managing resources, the method comprising:
generating a satellite beam to be output to a coverage area; and
allocating and outputting a frequency band of a satellite beam determined based on information on interference between a wireless signal to which a frequency band identical to the satellite beam is allocated and the satellite beam.

17. The method of claim 16, wherein the outputting comprises:
outputting a satellite beam at a minimum intensity to provide an amount of data required for the satellite beam, using transmitted power corresponding to the frequency band of the satellite beam.

18. A method of dynamically managing resources, the method comprising:
receiving a frequency band of a wireless signal determined based on information on interference between a satellite beam to which a frequency band identical to the wireless signal is allocated and the wireless signal; and
performing wireless communication by outputting, to a coverage area of a terrestrial network base station, a wireless signal to which the received frequency band of the wireless signal is allocated.

19. The method of claim 18, wherein the performing of the wireless communication comprises:
outputting the wireless signal at a minimum intensity to provide an amount of data required for the wireless signal, using transmitted power corresponding to the frequency band of the satellite beam.

20. The method of claim 18, wherein the performing of the wireless communication comprises:
outputting a wireless signal based on a received satellite beam, and
the frequency band of the wireless signal differs from a frequency band of the satellite beam received by the wireless communicator.
